(19) United States
(12) Patent Application Publication
(10) Pub. No.: US 2024/0408999 A1
(43) Pub. Date: Dec. 12, 2024

(54) Replaceable Battery Module

(71) Applicant: LG Energy Solution, Ltd., Seoul (KR)

(72) Inventor: Min Yong Jung, Daejeon (KR)

(73) Assignee: LG Energy Solution, Ltd., Seoul (KR)

(21) Appl. No.: 18/702,946

(22) PCT Filed: Apr. 21, 2023
(86) PCT No.: PCT/KR2023/005421

§ 371 Date: Apr. 19, 2024

(30) Foreign Application Priority Data
Apr. 25, 2022 (KR) 10-2022-0050507

(51) Int. Cl. B60L 53/80; H01M 50/249; H01M 50/264

(52) U.S. Cl. CPC B60L 53/80; H01M 50/249; H01M 50/264; H01M 2220/20

(57) ABSTRACT

A replaceable battery module related to one example of the present invention comprises a battery pack including a groove formed on an outer circumferential surface and a locking member elastically connected to the bottom surface of the groove, and a battery pack mounting part provided with a mounting space, in which the battery pack is detachably mounted, and a locking jaw which is locked and fixed with the locking member so that the position of the battery pack mounted in the mounting space is fixed.

### TECHNICAL FIELD

The present invention relates to a replaceable battery module, and an electric vehicle and a battery swap station comprising the same.

The present application claims the benefit of priority based on Korean Patent Application No. 10-2022-0050507 dated Apr. 25, 2022, the disclosure of which is incorporated herein by reference in its entirety.

### BACKGROUND ART

Light electric vehicle (LEV) markets are proposed as a solution to the problem of traffic congestion and parking shortage in large cities, and their use expands to various fields such as tourist destinations, golf carts, and distribution warehouses.

A small electric vehicle equipped with a battery pack requires battery charging for driving, but has a disadvantage that it takes a long time to charge the battery.

Recently, in order to shorten the battery charging time, a battery swap method has been considered. The battery swap method means a method of replacing a used battery with a fully charged battery, and the battery swap method can provide convenience to an electric vehicle driver because the battery can be replaced within a short time.

### DISCLOSURE

### Technical Problem

It is a problem to be solved by the present invention to provide a replaceable battery module capable of quickly replacing a battery pack through a simple coupling structure, and an electric vehicle and a battery swap station comprising the same.

### Technical Solution

In order to solve the above problem, a replaceable battery module related to one example of the present invention comprises a battery pack including a groove formed on an outer circumferential surface and a locking member elastically connected to the bottom surface of the groove, and a battery pack mounting part provided with a mounting space, in which the battery pack is detachably mounted, and a locking jaw which is locked and fixed with the locking member so that the position of the battery pack mounted in the mounting space is fixed.

Also, when the battery pack is mounted in the mounting space, the locking member may pass from one end of the locking jaw to the other end, and be locked and fixed to the other end of the locking jaw after passing through the locking jaw.

In addition, the locking member is pressed from the locking jaw upon passing from one end of the locking jaw to the other end, and moved toward the bottom surface of the groove.

Furthermore, the locking member passes through the locking jaw, and then moves in a direction away from the bottom surface of the groove as the force pressed from the locking jaw is released.

Also, the locking jaw may be provided such that one end has a thickness increasing along the mounting direction of the battery pack, and the locking member may be provided to pass through one end of the locking jaw while sliding in a state of being in contact with one end.

In addition, the locking member may comprise a head part exposed to the outside of the battery pack, a body part connecting the head part and the bottom surface of the groove, and a spring member mounted on the body part.

Furthermore, the bottom surface of the groove has a through hole through which the body part passes.

Also, the spring member may be provided to be compressed when the head part moves toward the bottom surface of the groove.

In addition, the locking member may comprise a separation preventing member that is coupled to a portion of the body part penetrating the through hole to prevent separation of the locking member from the groove.

Furthermore, the battery pack mounting part may comprise a coupling release part for releasing the locking coupling of the locking member when the battery pack is separated from the mounting space.

The coupling release part may comprise a push button positioned on an outer circumferential surface of the battery pack mounting part, and a rod connected to the push button and having one end which penetrates the outer circumferential surface to be exposed to the mounting space.

Also, when the push button is pressed in a mounting state of the battery pack, one end of the rod may move the locking member toward the bottom surface of the groove.

In addition, after the locking member is moved toward the bottom surface of the groove by the rod, the locking member is in a state capable of passing to one end of the locking jaw from the other end. At this time, when a user applies an external force in a direction opposite to the mounting direction of the battery pack, the battery pack may be separated from the battery pack mounting part.

Furthermore, according to another aspect of the present invention, an electric vehicle comprising the replaceable battery module is provided.

In addition, according to another aspect of the present invention, a battery swap station comprising the replaceable battery module is provided.

### Advantageous Effects

As described above, according to the replaceable battery module related to at least one example of the present invention, and the electric vehicle and the battery swap station comprising the same, the battery pack can be quickly replaced through a simple coupling structure.

### DESCRIPTION OF DRAWINGS

FIG. 1 is a cross-sectional diagram of a replaceable battery module according to one example of the present invention.

FIGS. 2 to 4 are operating state diagrams for explaining a process of mounting and separating a battery pack in the replaceable battery module shown in FIG. 1.

FIGS. 5 to 7 are diagrams showing the locking member in detail.

FIG. 8 is a configuration diagram schematically showing an electric vehicle related to one example of the present invention.

FIG. 9 is a configuration diagram schematically showing a battery swap station related to one example of the present invention.

### MODE FOR INVENTION

Hereinafter, a replaceable battery module according to one example of the present invention, and an electric vehicle and a battery swap station comprising the same will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

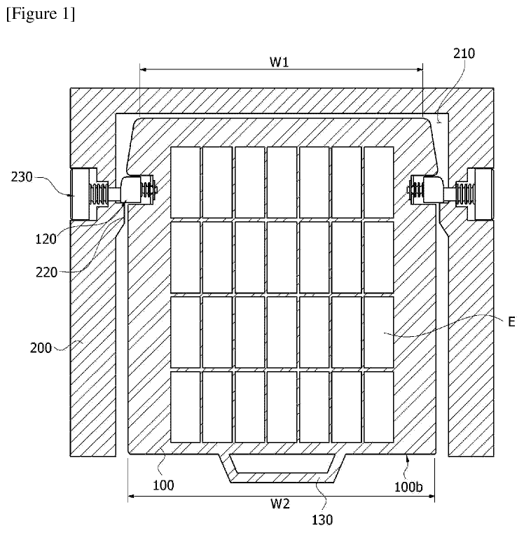

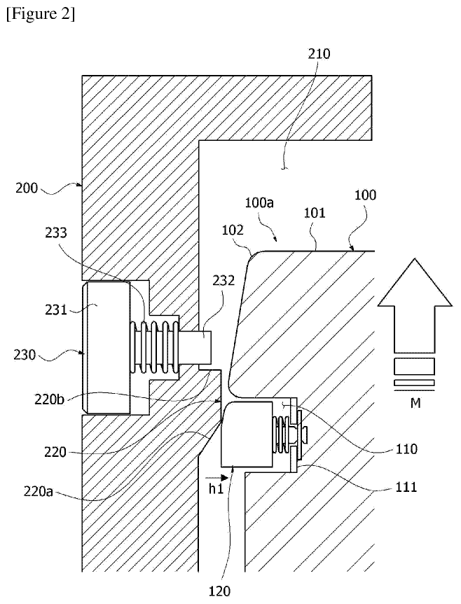

FIG. 1 is a cross-sectional diagram of a replaceable battery module according to one example of the present invention, and FIGS. 2 to 4 are operating state diagrams for explaining a process of mounting and separating a battery pack in the replaceable battery module shown in FIG. 1.

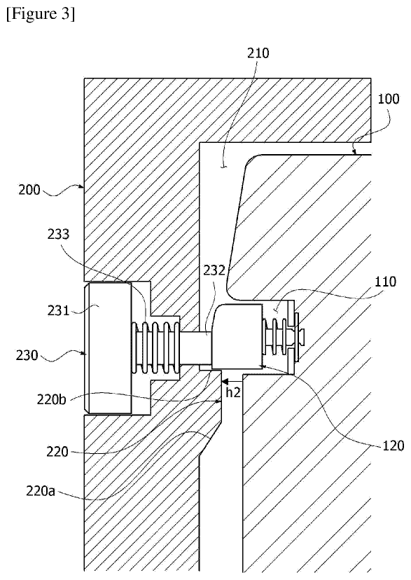

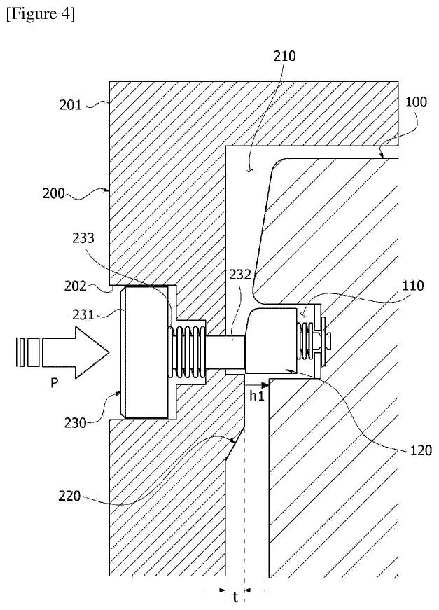

Specifically, FIG. 2 is an operating state diagram for explaining a process of mounting a battery pack, FIG. 3 is an operating state diagram for explaining a mounting completion state of a battery pack, and FIG. 4 is an operating state diagram for explaining a process of separating a battery pack.

The present invention relates to a replaceable battery module. Also, the electric vehicle according to one example of the present invention comprises the replaceable battery module. In addition, the battery swap station according to one example of the present invention comprises the replaceable battery module. In detail, the replaceable battery module may be applied to a light electronic vehicle (LEV) or a battery swap station (also referred to as a ‘battery charging station’).

Referring to FIG. 1, the replaceable battery module related to one example of the present invention comprises a battery pack (100) and a battery pack mounting part (200). The battery pack mounting part (200) may be provided in an electric vehicle, or may be provided in a battery charging station.

The replaceable battery module comprises a battery pack (100) including a groove (110) formed on an outer circumferential surface (102) and a locking member (120) elastically connected to the bottom surface (111) of the groove (110), and a battery pack mounting part (200) provided with a mounting space (210) in which the battery pack (100) is detachably mounted, and a locking jaw (220) which is locked and fixed with the locking member (120) so that the position of the battery pack (100) mounted in the mounting space (210) is fixed.

The battery pack (100) may comprise a case (101) and a plurality of secondary battery cells (E) accommodated inside the case (101). The outer circumferential surface of the battery pack (100) means the outer circumferential surface (102) of the case (101).

Also, the battery pack (100) may be electrically connected to the battery pack mounting part (200) in a state of being mounted in the mounting space (210) within the battery pack mounting part (200). As the battery pack (100) and the battery pack mounting part (200) are electrically connected to each other, power is supplied from a battery charging station to the battery pack (100), so that the battery pack may be charged. In addition, the power may be supplied from the battery pack (100) to an electric motor, which is a driving source of an electric vehicle.

Specifically, the battery pack (100) comprises a groove (110) formed on an outer circumferential surface (102) and a locking member (120) elastically connected to the bottom surface (111) of the groove (110). As the locking member (120) is elastically connected to the bottom surface (111) of the groove (110), it is provided to enable pressing movement toward the bottom surface (111) of the groove (110) and return to its original position.

The locking member (120) is pressed and moved toward the bottom surface (111) of the groove by an external force, and moved in a direction away from the bottom surface (111) of the groove, when the external force is released, to return to its original position. The external force may be generated by contact with the locking jaw (220) to be described below. At this time, the direction in which the locking member (120) moves toward the bottom surface (111) of the groove (110) is referred to as a first direction (h1), and the direction in which the locking member (120) moves away from the bottom surface (111) of the groove (110) is referred to as a second direction (h2). At this time, the first direction (h1) and the second direction (h2) are directions opposite to each other.

Also, in the battery pack (100), the width (W1) of the front end (100a) and the width (W2) of the rear end (100b) may be different from each other. The front end (100a) of the battery pack (100) is a part that first enters the mounting space (210) when inserted into the mounting space, and the region in the opposite direction of the front end (100a) is referred to as the rear end (100b).

Referring to FIG. 1, the battery pack (100) has the width (W1) of the front end (100a) relatively narrower than the width (W2) of the rear end (100b) so as to facilitate entry into the mounting space (210). In addition, the battery pack (100) may be provided with a handle (130) at the rear end (100b) side.

The battery pack mounting part (200) comprises a mounting space (210) in which the battery pack (100) is detachably mounted, and a locking jaw (220) locked and fixed to the locking member (220) so that the position of the battery pack (100) mounted in the mounting space (210) is fixed.

Referring to FIG. 2, when the battery pack (100) is mounted, the locking member (120) may pass from one end (220a) of the locking jaw (220) to the other end (220b), and when the passage is completed, it may be locked and fixed to the other end (220b) of the locking jaw (220).

In a state of being locked and fixed, the locking member (120) may be in contact with at least a portion of the other end (220b) of the locking jaw (220). One end (220a) of the locking jaw (220) is positioned adjacent to an entrance through which the battery pack (100) enters the mounting space.

The locking jaw (220) may be provided such that a thickness (t) of one end (220a) increases along the mounting direction (M) of the battery pack. At this time, the locking member (120) may pass through one end (220a) while sliding in contact with one end (220a) of the locking jaw (220) along the mounting direction (M) of the battery pack.

In addition, when the locking member (120) passes from one end (220a) of the locking jaw (220) to the other end (220b), it may be pressed from the locking jaw (220) to move toward the bottom surface (111) of the groove.

That is, when the battery pack (100) enters the mounting space (210) along the mounting direction (M), the locking member (120) may be moved in the first direction (h1) by the locking jaw (220), and the locking member (120) may be gradually moved in a direction closer to the bottom surface (111) of the groove (110) by the thickness (t) of the locking jaw (220).

Also, when the passage from one end (220a) of the locking jaw (220) to the other end (220b) is completed, the locking member (120) may be elastically returned to its original position as the force pressed from the locking jaw (220) is released. As the locking member (120) is elastically returned to its original position, at least a portion may be in contact with the other end (220b) of the locking jaw (220). The contacted portion performs a locking and fixing role.

In addition, one end (220a) of the locking jaw (220) may have an inclined surface, and the locking member (120) may pass through the locking jaw (220) while sliding along the slope of the inclined surface. In order to minimize friction with the inclined surface, a portion of the locking member (120) in contact with the inclined surface may be rounded.

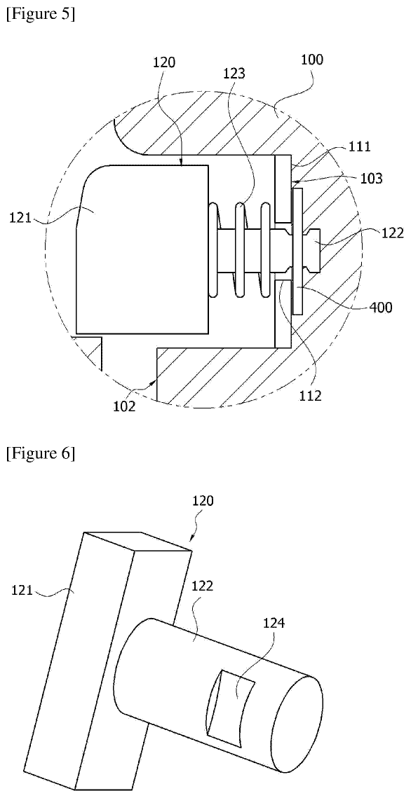

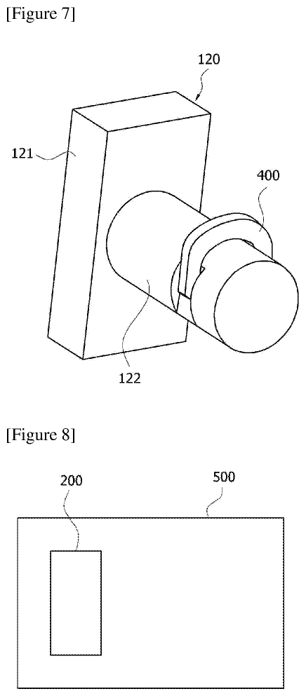

FIGS. 5 to 7 are diagrams showing the locking member (120) in detail.

The locking member (120) may comprise a head part (121) exposed to the outside of the battery pack (100) to be capable of being locked and fixed with the locking jaw (220), a body part (122) connecting the head part (121) and the bottom surface (111) of the groove (110), and a spring member (123) mounted to the body part (122). At this time, the spring member (123) may be provided to be compressed when the head part (121) moves toward the bottom surface (111) of the groove (110). That is, when the head part (121) moves in the first direction (h1) by an external force, the spring member (123) is compressed. Conversely, when the external force is released, the head part (121) moves in the second direction (h2) while the spring member (123) is elastically restored.

The head part (121) may have an approximately rectangular parallelepiped shape, and may be formed so that the corners are rounded. The head part (121) is substantially slid along the inclined surface of one end (220a) of the locking jaw (220), which is a portion locked and fixed with the other end (220b) of the locking jaw (220).

In addition, the body part (122) may have a bar shape and may be connected to the center of the head part (121). The spring member (123) may be provided to surround the body part (122) so that the body part (122) penetrates the inside. The spring member (123) may provide a restoring force that elastically returns to the original position after the head part (121) is pressed and moved. As one example, the spring member (123) may be a coil spring. Furthermore, the groove (110) may also be provided with a rail part guiding the movement of the head part (121).

Referring to FIGS. 5 to 7, the bottom surface (111) of the groove (110) may have a through hole (112) through which the body part (122) passes. The through hole (112) may be located at the center of the bottom surface (111) of the groove (110).

In addition, the locking member (120) may comprise a separation preventing member (400) that is coupled to a portion of the body part (122) penetrating the through hole (112) to prevent separation of the locking member (120) from the groove (110).

The separation preventing member (400) may be a clip member, for example, a C-clip. The body part (122) penetrating the through hole (112) may have a clip groove (124) for which the clip member is inserted.

The through hole (112) penetrates the outer circumferential surface (102) and the inner circumferential surface (103) of the case (101), and the separation preventing member (400) is disposed on the inner circumferential surface (103). The inner circumferential surface (103) of the case (101) surrounds the mounting space (210).

In addition, the battery pack mounting part (200) may comprise a coupling release part (230) for releasing the locking coupling of the locking member (120) when the battery pack (100) is separated from the mounting space.

Referring to FIGS. 2 to 4, the coupling release part (230) comprises a push button (231) positioned on an outer circumferential surface (201) of the battery pack mounting part (200), and a rod (232) connected to the push button (231) and having one end which penetrates the outer circumferential surface (201) to be exposed to the mounting space (210). On the outer circumferential surface (201) of the battery pack mounting part (200), a depressed part (202) is formed, where the push button (231) may be disposed within the depressed part (202). In addition, the rod (232) penetrates the depressed part (202) to extend into the mounting space (210).

Referring to FIG. 4, in a state where the battery pack (100) is mounted in the mounting space (210), when the push button (231) is pressed from the outside of the battery pack mounting part (200), one end of the rod (232) moves the locking member (120) toward the bottom surface (111) of the groove (110). As the locking member (120) is moved in the first direction (h1), the locking coupling between the locking member (120) and the locking jaw (220) may be released.

When the push button (231) is pressed in a state of mounting the battery pack (100), one end of the rod (232) moves the locking member (120) toward the bottom surface (111) of the groove (110). Also, after the locking member (120) is moved toward the bottom surface (111) of the groove (110) by the rod (232), the locking member (120) enables to pass to one end (220a) of the locking jaw (220) from the other end (220b).

In addition, the coupling release part (230) may comprise a spring member (233) mounted on the rod (232). The spring member (233) may be mounted in a state surrounding the rod (232) so that the rod (232) penetrates the inside. The spring member (233) may provide a restoring force that elastically returns to the original position after the push button (231) is pressed.

Referring to FIGS. 3 and 4, when the push button (231) is pressed by an external force and the rod (122) moves in the first direction (h1), the spring member (233) is compressed. Conversely, when the external force applied to the push button is released, the rod (122) moves in the second direction (h2) while the spring member (233) is elastically restored. As one example, the direction (P) in which the push button (231) is pressed may be the same direction as the first direction (h1).

The replaceable battery module according to the present invention may further comprise a cover (not shown) coupled to the battery pack mounting part. The cover is coupled to the battery pack mounting part (200) so that the mounting space (210) of the battery pack mounting part (200) is sealed. The cover prevents the mounted battery pack (100) from being separated, and serves to protect the battery pack (100) from being damaged by external impacts.

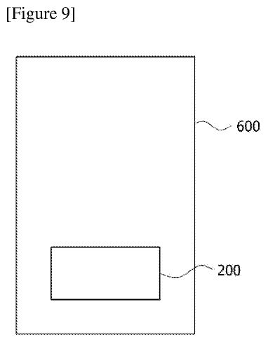

FIG. 8 is a configuration diagram schematically showing an electric vehicle (500) related to one example of the present invention, and FIG. 9 is a configuration diagram schematically showing a battery swap station (600) related to one example of the present invention.

Referring to FIG. 8, the present invention may be an electric vehicle (500) comprising the above-described replaceable battery module. The electric vehicle (500) comprises a battery pack mounting part (200), where a battery pack may be detachably mounted on the battery pack mounting part (200). The type of the electric vehicle (500) is not particularly limited if the replaceable battery module may be mounted, which may be a small, medium, or large electric vehicle, and preferably may be a small electric vehicle. The small electric vehicle may be exemplified by, for example, an electric scooter, an electric bicycle, or a quick board, and the like. The electric vehicle comprising the above-described replaceable battery module has an advantage of shortening a replacement time when replacing an old battery pack with a new battery pack.

Referring to FIG. 9, the present invention relates to a battery swap station (600) comprising the above-described replaceable battery module. The battery swap station (600) may supply power to the battery pack through the battery pack mounting part (200) to charge the battery pack. The battery swap station comprising the above-described replaceable battery module has an advantage that the replacement time consumed when mounting an old battery pack or separating a fully charged battery pack is reduced.

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the replaceable battery module related to one example of the present invention, and the electric vehicle and the battery swap station comprising the same, replacement of a battery pack can be quickly performed through a simple coupling structure.

1. A replaceable battery module comprising:
a battery pack including a groove formed extending into an outer circumferential surface thereof and a locking member elastically coupled to a bottom surface of the groove; and
a battery pack mounting part defining a mounting space therein, in which the battery pack is detachably mounted, the battery pack having a locking jaw which is locked to the locking member so that the position of the battery pack mounted in the mounting space is fixed.

2. The replaceable battery module according to claim 1, wherein the replaceable battery module is configured such that when the battery pack is inserted into the mounting space, the locking member passes from a first end of the locking jaw to a second end of the locking jaw, and the locking member is locked to the second end of the locking jaw after passing through the locking jaw.

3. The replaceable battery module according to claim 2, wherein the locking member is configured to be pressed by the locking jaw upon passing from the first end of the locking jaw to the second end and is configured to be moved toward the bottom surface of the groove.

4. The replaceable battery module according to claim 3, wherein the locking member is configured to pass through the locking jaw and then move in a direction away from the bottom surface of the groove as a force applied thereto from the locking jaw is released.

5. The replaceable battery module according to claim 1, wherein the first end of the locking jaw has a thickness increasing along a mounting direction of the battery pack, and the replaceable battery module is configured such that the locking member passes through the first end of the locking jaw while sliding in a state of being in contact with the first end.

6. The replaceable battery module according to claim 1, wherein the locking member comprises:
a head part exposed to an outside of the battery pack;
a body part connecting the head part and the bottom surface of the groove; and
a spring member mounted on the body part.

7. The replaceable battery module according to claim 6, wherein the bottom surface of the groove has a through hole through which the body part passes.

8. The replaceable battery module according to claim 6, wherein the spring member is configured to be compressed when the head part moves toward the bottom surface of the groove.

9. The replaceable battery module according to claim 7, wherein the locking member comprises a separation preventing member that is coupled to a portion of the body part penetrating the through hole and that is configured to prevent separation of the locking member from the groove.

10. The replaceable battery module according to claim 1, wherein the battery pack mounting part comprises a coupling release part configured to release the locking coupling of the locking member when the battery pack is separated from the mounting space.

11. The replaceable battery module according to claim 10, wherein the coupling release part comprises:
a push button positioned on an outer circumferential surface of the battery pack mounting part; and
a rod connected to the push button and having one end which penetrates the outer circumferential surface of the battery pack mounting part and is exposed to the mounting space,
wherein the replaceable battery module is configured such that when the push button is pressed in a mounting state of the battery pack, the one end of the rod moves the locking member toward the bottom surface of the groove.

12. The replaceable battery module according to claim 11, wherein the replaceable battery module is configured such that after the locking member is moved toward the bottom surface of the groove by the rod, the locking member is capable of passing to a first end of the locking jaw from a second end of the locking jaw.

13. An electric vehicle comprising the replaceable battery module according to claim 1.

14. A battery swap station comprising the replaceable battery module according to claim 1.
